(19) United States
(12) Patent Application Publication
(10) Pub. No.: US 2010/0151224 A1
(43) Pub. Date: Jun. 17, 2010

(54) METHOD FOR PARTIALLY COATING OPEN CELL POROUS MATERIALS

(75) Inventors: Emmanuelle Gros, Shefford (CA); Dominic Pilon, Montreal (CA)

Correspondence Address: Osler, Hoskin & Harcourt LLP (Metafoam), 1000 de La Gauchetiere Street West, Suite 2100, Montreal, QC, H3B 4W5, CA

(73) Assignee: METAFOAM TECHNOLOGIES INC.

(21) Appl. No.: 12/295,341

(22) PCT Filed: Mar. 29, 2007
(86) PCT No.: PCT/CA2007/000500

§ 371 Date: Oct. 17, 2008

Related U.S. Application Data
(60) Provisional application No. 60/744,000, filed on Mar. 30, 2006.

(51) Int. Cl. B32B 3/26; B05D 3/02

(52) U.S. Cl. 428/304.4; 427/256; 427/287; 427/372.2

(57) ABSTRACT

A method for partially coating open cell porous material is provided. The method generally comprises the initial step of providing a block or body of open cell porous material made from a first material having a first melting temperature. A thin sheet of a second material, having a second melting temperature lower than the first melting temperature, is then disposed on one or more of the exterior surfaces of the open cell porous block. The block and the sheet are then placed in an oven or a retort at generally the second melting temperature. By capillarity, the molten second material will spread throughout the open cell porous block and generally concentrates itself in the regions where adjacent particles of the first material have previously partially bonded.

### CROSS-REFERENCE TO RELATED APPLICATIONS

The present patent application claims the benefits of priority of commonly assigned U.S. Provisional Patent Application No. 60/744,000, entitled “Method for Partially Coating Open Cell Porous Materials and Material Made Therewith” and filed at the United States Patent and Trademark Office on Mar. 30, 2006.

### FIELD OF THE INVENTION

This invention relates to the field of open cell porous materials, and in particular, to methods for adding coating on these materials.

### BACKGROUND OF THE INVENTION

Porous materials are actually used in devices such as filters, sound absorbers, heat sinks (electronic cooling), electrodes, shock absorbers, heat exchangers, biomaterials, fuel cells, etc. The structure may be classified in two important categories: closed cell and open cell. Closed cell materials are principally used in structural applications like shock absorbers while open cell materials are principally used when exchange phenomena take place or when permeability or pore connectivity is needed. Open cell materials are generally more fragile than closed cell materials.

In porous or granular materials, crumbling frequently occurs, and in particular when the material comes from a powder metallurgy process as per U.S. Pat. No. 6,660,224 process for example. Sintering helps to get better metallurgical links between the particles but sometimes crumbling occurs nevertheless.

Conducting surfaces are conventionally coated by electroplating. Electroplating is the deposition of a metallic coating onto an object by putting a negative charge onto the object and immersing it into a solution which contains a salt of the metal to be deposited. The metallic ions of the salt carry a positive charge and are attracted to the part. When they reach it, the negatively charged part provides the electrons to “reduce” the positively charged ions to metallic form. Nonconducting surfaces can also be coated by electroplating as per patent U.S. Pat. No. 6,565,731 for example. However, when the material is porous, it has to be permeable enough to let the solution pass through the pores. Furthermore, electroplating cannot be used with all conductive material. For instance, aluminium cannot be plated since aluminium cannot be deposited from an aqueous electrolyte.

Another process for coating surfaces is Chemical Vapor Deposition (CVD). The basic steps of CVD are: vaporization and transport of precursor molecules into reactor, diffusion of precursor molecules to surface, adsorption of precursor molecule to surface, decomposition of precursor molecules on surface and incorporation into solid films, recombination of molecular by-products and desorption into gas phase. CVD is however limited in the thickness it can reach.

In open cell porous material production, when the piece is only sintered, integrity problems often occur. In order to enhance the structural integrity of the porous material, it is possible to coat it with another material. An example of this method is taught in European Patent No. 1 477 578 wherein a core metal foam (e.g. open cell porous material) is dipped into a liquid metal bath comprising the second metal or alloy. However, the main problem with this method is that by completely dipping a porous material in a bath of molten metal, the smallest pores or cells usually come out of the treatment obstructed or filled, therefore reducing the porosity of the porous material, its permeability, and its specific surface area. Furthermore, this method requires the maintaining of a bath of molten metal, which can become costly in terms of energy consumption.

An alternative embodiment of the previously cited method is also taught in European Patent No. 1 477 578. A number of pieces of core metal foam having predetermined shapes (e.g. rectangular) are pilled up with sheets of the second metal or alloy, in an alternating manner. This assembly is then heated in a furnace in which temperature and atmosphere are adjusted in such a way that the sheets of second metal or alloy melt and spread into the pieces of core metal foam, the temperature of the furnace being however below the melting temperature of the core metal foam. Hence, the core metal foam remains solid while the sheets of second metal or alloy melt and the liquid second metal or alloy distributes in the pieces of the core metal foam. After solidification of this assembly, a large body of metal foam is obtained, which consists of core metal foam pieces united by a thick coating layer of the second metal or alloy. As in the previously cited method, the main problem with this method is that by completely coating the porous material with the second metal or alloy, the smallest pores or cells usually come out of the treatment obstructed or filled, therefore reducing the porosity of the porous material, its permeability, and its specific surface area.

Hence, there is a need for an alternative method for producing a partial coating that is simple, cost effective, can coat a large thickness sample (>30 mm), has variable thickness, keeps the porosity open (minimize cell filling) and does not significantly decrease the specific surface area and permeability of the core metal foam.

### SUMMARY OF THE INVENTION

The present invention provides a method for partially coating an open cell porous or granular structure by a compatible material while preserving the open porosity.

It has been found surprisingly that the partial wetting of the initial porous structure by another material sometimes leads to new functionalities and/or to improved physical properties in the initial porous structure.

The method of the present invention starts preferably with a block or a body of open cell porous material made of a first material. The first material can be a metal (e.g. a transition metal), a metal alloy, a ceramic material or a coated material. In any case, the material generally has a first melting temperature.

The block of open cell porous material is generally made from one of the known production methods such as the one given in U.S. Pat. No. 6,660,224. Understandably, the previous example is non limitative in nature. Essentially, in the method recited in U.S. Pat. No. 6,660,224, the first material, in powder form, is mixed with a solid organic binder having clean burn out characteristics and with a foaming agent. The mixture is then shaped into a predetermined form. The resulting product is then heated to melt the binder and to activate the foaming agent, which induces foaming in the mixture. Once the foaming is over, the foamed mixture is heated again under predetermined conditions of atmosphere, duration and temperature sufficient to ensure a clean burn out of the binder. The remaining open cell porous structure is then sintered to assure that at least a partial bond is formed between adjacent particles of the first material. The sintering step generally enhances the structural integrity of the open cell porous material.

According to the present invention, a thin sheet of a second material, having a second melting temperature, is then disposed onto the block of open cell porous material. The thin sheet of a second material can be disposed on any outside surface of the block but preferably on the top or bottom surface. The melting temperature of the thin sheet of the second material is understandably lower than the first melting temperature. Hence the second material, comprising the thin sheet, can be any compatible material as long as its melting temperature is lower than the melting temperature of the first material.

The block of open cell porous material and the thin sheet are then placed in an oven or a retort at a temperature which is equal or greater than the second melting temperature but lower than the first melting temperature. The thin sheet will therefore melt and by virtue of capillarity, or wicking effect, of the open cell porous structure of the block, the molten second material will spread throughout the block of open cell porous material.

As it has been found, the molten second material will generally concentrate itself near the bonding region between two adjacent particles of the first material where the two adjacent particles have bonded during the sintering phase. The remaining surface of the particles is generally free of the second material, hence generally creating only a partial coating.

Therefore, by adding more material to the bonding region, the bond between two adjacent particles is stronger, which can lead to enhanced mechanical properties. Moreover, since the second material is concentrated in these bonding regions and generally not elsewhere, the cells of the open cell porous block are generally not filled by the second material and the porosity of the open cell porous material thus remains substantially the same.

Furthermore, depending on the nature of the second material, other interesting properties can be derived from the partially coated open cell porous material.

The features of the present invention which are believed to be novel are set forth with particularity in the appended claims.

### BRIEF DESCRIPTION OF THE DRAWINGS

Other aspects and many of the attendant advantages will be more readily appreciated as the same becomes better understood by reference to the following detailed description and considered in connection with the accompanying drawings wherein:

FIG. 1 is a scanning electron microscope picture at 100 μm of a porous open cell body before the partial coating process.

FIG. 2 is a scanning electron microscope picture at 100 μm of a porous open cell body after the partial coating process.

FIG. 3 is a scanning electron microscope picture at 500 μm of a porous open cell body before the partial coating process.

FIG. 4 is a back scattered scanning electron microscope picture at 500 μm of a porous open cell body after the partial coating process.

FIG. 5 is a back scattered scanning electron microscope picture at 50 μM of a porous open cell body after the partial coating process.

FIG. 6 is a scanning electron microscope picture at 20 μm of a porous open cell body after the partial coating process.

### DETAILED DESCRIPTION OF THE PREFERRED EMBODIMENT

A novel method for partially coating open cell porous materials will be described hereinafter. Although the invention is described in terms of specific illustrative embodiments, it is to be understood that the embodiments described herein are by way of example only and that the scope of the invention is not intended to be limited thereby.

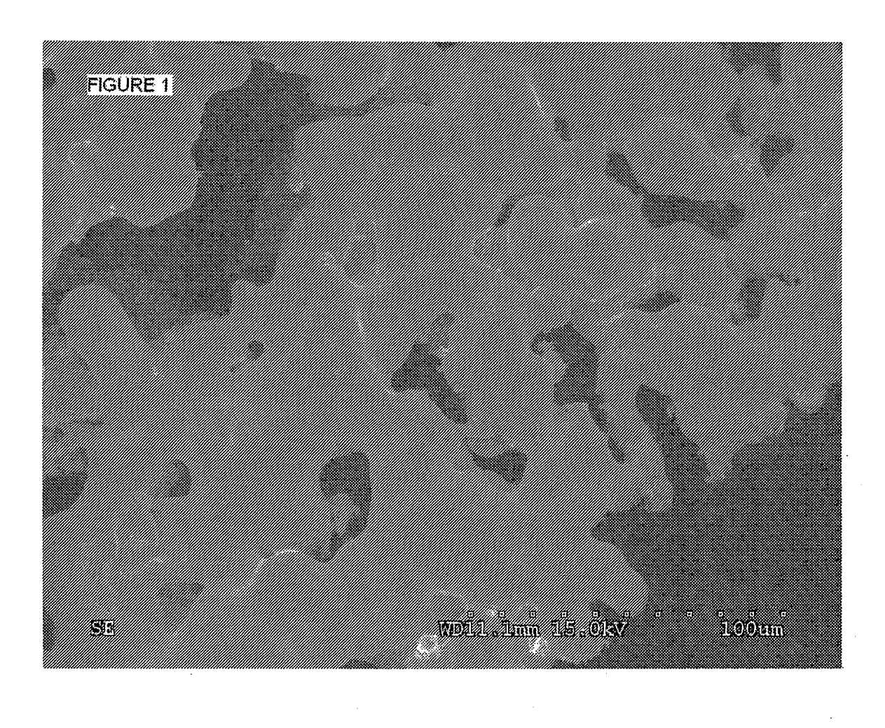

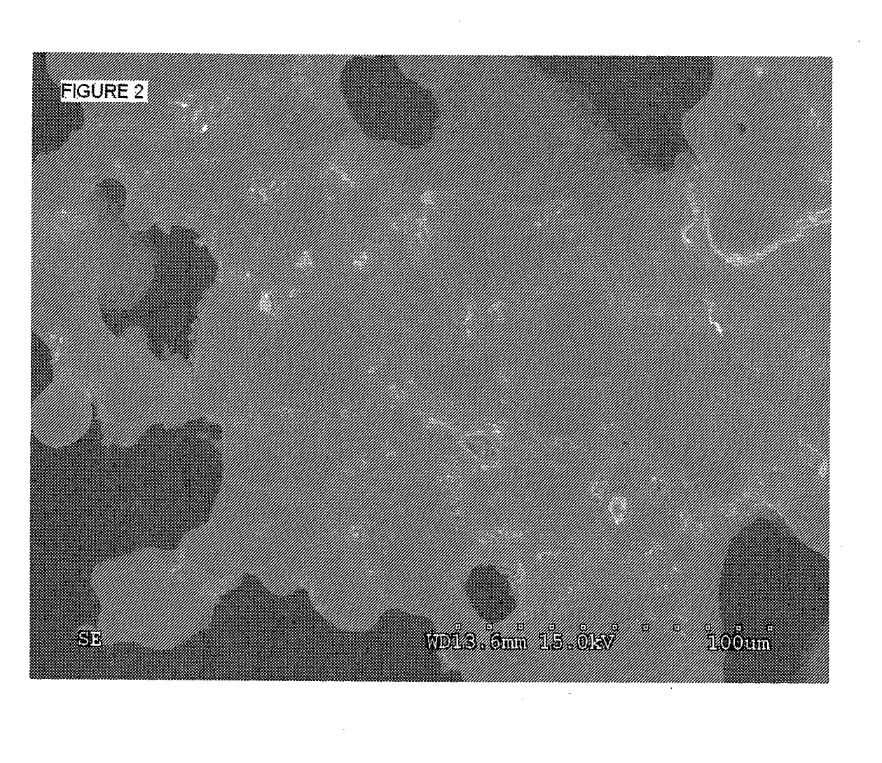

Referring now to FIGS. 1 and 2, we can see scanning electron microscope pictures at 100 μm of porous open cell bodies before (FIG. 1) and after (FIG. 2) the method of the present invention.

### General Method

The method of the present invention starts with a block or body of open cell porous material made from a first material. The starting porous body can be made according to different methods as it is generally known in the art (for non limitative examples, see U.S. Pat. Nos. 2,917,384, 3,078,552 and 6,660,224). In the previously cited example, open cell porous body are made by mixing a first material (e.g. metal, metal alloy, ceramic, metal coated material, etc.), having a first melting temperature and being generally provided in granulated or powdered form, with a binder and a foaming agent. The mixture is then heated to activate the foaming agent and therefore to induce foaming of the mixture. The foamed mixture is then placed in an oven or a retort in order to burn, pyrolyse and/or degrade the binder. The remaining fragile porous structure is then heated at a temperature high enough to at least sinter adjacent particles of the first material. The resulting structure is a block or body of open cell porous material.

A thin sheet of a second material, having second melting temperature lower than the first melting temperature, is placed on the top face, and/or under the bottom face and/or on the side faces of the porous body. The second material can be any compatible material, for example but not limited to brazing alloys, polymers, and heavy metals, as long as the melting temperature of the second material is lower than the melting temperature of the first material. The porous body and the thin sheet are then placed into an oven or a retort at a temperature high enough to induce melting of the thin sheet but lower than the first melting temperature to prevent melting of the porous body.

In the oven, the thin sheet of second material will melt and by virtue of capillarity (wicking effect), the molten second material will spread throughout the porous body.

Contrary to prior art process and as it will be shown hereunder, the molten second material will not coat all the surface of the porous body. In fact, the molten second material will generally concentrate itself in the bonding area or region between two adjacent particles of the first material. The remaining surface remains substantially, but not completely, free of the second material. Hence, block of open cell porous material is only partially coated.

One embodiment of the present invention shall be described in the non limitative following example.

### Example

Open cell porous copper (Cu) samples were produced with the formulation presented in Table 1 and in accordance with the procedure described in U.S. Pat. No. 6,660,224. The different constituents were dry-mixed together until the mixture became homogeneous. After mixing, the mixture was poured into a mold and foamed at 110° C. in air for 2 hours. After foaming, the material was submitted to the debinding step in a tube furnace at 650° C. for 4 hours in a dry air stream. Finally, the specimens were sintered in an Ar-25% H₂ atmosphere for 3 hours at 950° C.

TABLE 1
Formulation used for the production of the Cu foam

| Metallic powder | Binder | Foaming agent |
|---|---|---|
| Cu powder | Phenolic resin | P-toluene sulfonyl hydrazide |
| 70 wt. % | 29.5 wt. % | 0.5 wt. % |

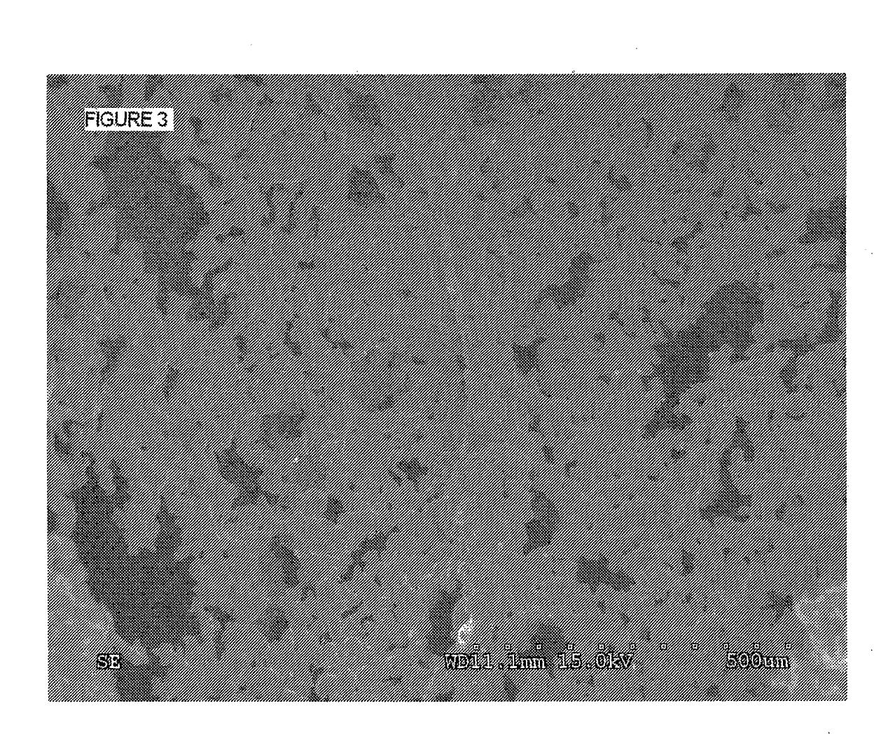

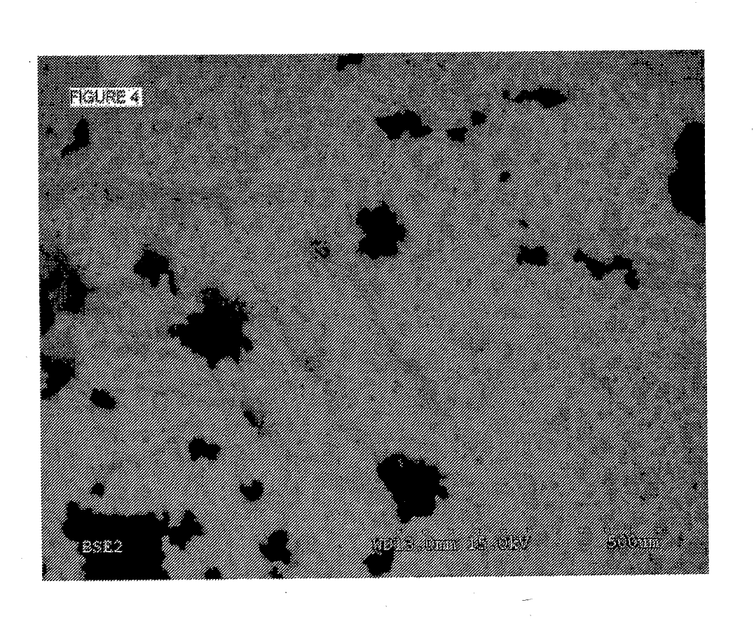

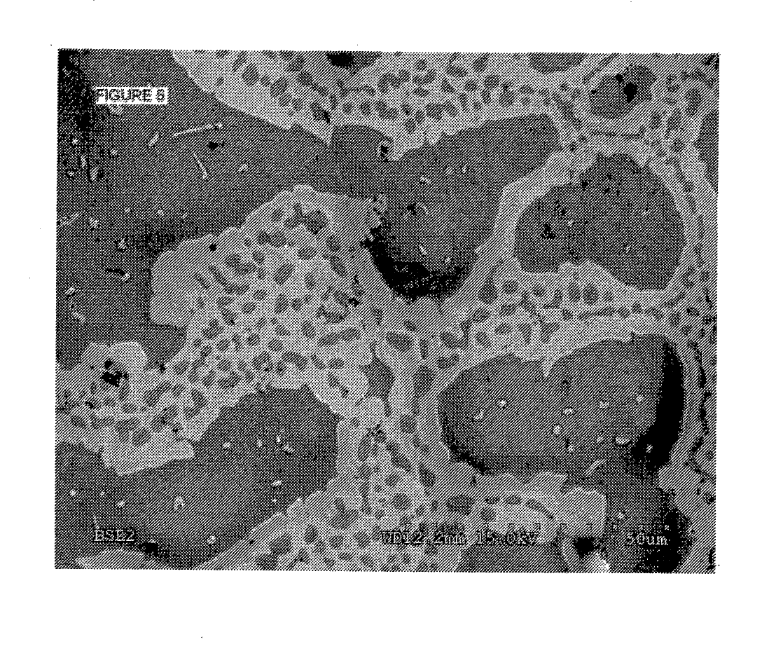

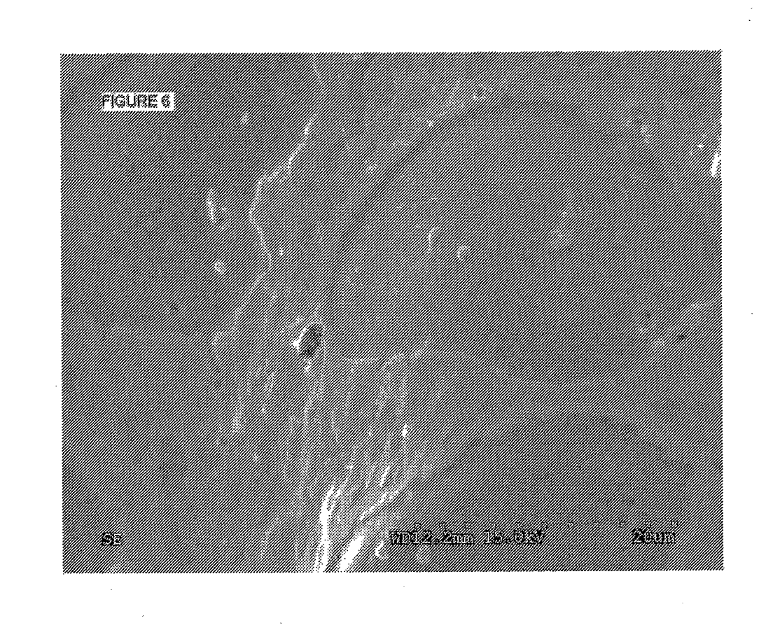

FIGS. 1 and 3 show scanning electron microscope pictures of the open cell porous Cu samples after their production but before the partial coating process. A 0.010″ thick sheet of silver based brazing alloy (the second material), with a nominal composition of at least 72 wt. % of silver and with the remaining wt. % of composition being copper, was then machined to the same lateral dimension as the open cell porous Cu sample. The open cell porous Cu sample and the brazing sheet were then placed together, with the brazing sheet on the top face of the open cell porous Cu sample, in a tube furnace for heating in an Ar-25% H₂ atmosphere at 785° C. for 30 minutes. After 30 minutes, the sheet of the second material melted, and through capillarity (wicking effect), partially coated the surface of the open cell porous Cu sample. FIGS. 2, 4, 5, and 6 show pictures of the open cell porous Cu sample partially coated by the sheet of silver based brazing alloy. In all four figures, the second material is the one represented by the light shades of grey and the first material, e.g. the copper, by the dark shades of grey. It can be clearly seen that the molten second material generally concentrate itself in the bonding area or region between two adjacent particles of the first material. The remaining surface remains substantially, but not completely, free of the second material.

Compression tests were done using a 100 kN MTS hydraulic machine on two initially identical open cell porous copper samples. Prior to the test, one sample was partially coated with the silver based brazing alloy as the second material using the presently described process. The other sample was not coated. The partially coated open cell porous copper sample had a Young's modulus and a yield stress around 340 MPa and 1.85 MPa respectively. As for the sample that was not partially coated, its Young's modulus and yield stress were around 105 MPa and 0.25 MPa respectively. This demonstrates that by using the partial coating process of the present invention, it is possible to enhance the mechanical properties of the initial open cell porous material.

Furthermore, microbiological tests were done using an open cell porous copper sample partially coated with a silver based brazing alloy. It was found that because of the presence of heavy metals, namely silver, the partially coated open cell porous copper also presented anti-bacterial functionality. This new functionality allowed for the removal of bacteria, for example e. coli, from water sample after the water spent a short amount of time in contact with the partially coated open cell porous material.

Although preferred embodiment of the invention have been described in detail herein and illustrated in the accompanying figures, it is to be understood that the invention is not limited to these precise embodiment and that various changes and modifications may be effected therein without departing from the scope or spirit of the present invention.

1. A method for at least partially coating an open cell porous body made from a first material having a first melting temperature, said method comprising the steps of:
a. providing said open cell porous body, said body having a first exterior surface;
b. placing a sheet of a second material adjacent to said first exterior surface, said second material having a second melting temperature lower than said first melting temperature, said second material being compatible with said first material;
c. heating said body with said sheet at a third temperature, said third temperature being equal or greater than said second melting temperature but lower than said first melting temperature.

2. A method as claimed in claim 1, wherein said first material is essentially a non-metallic material.

3. A method as claimed in claim 1, wherein said first material is essentially a ceramic material.

4. A method as claimed in claim 1, wherein said first material is essentially a metallic material.

5. A method as claimed in claim 1, wherein said first material is a non-metallic material or a ceramic material or a metallic material or a combination thereof.

6. A method as claimed in claim 4, wherein said metallic material is essentially a metal or a metallic alloy.

7. A method as claimed in claim 4, wherein said metallic material comprises at least one transition metal.

8. A method as claimed in claim 7, wherein said at least one transition metal is scandium or titanium or vanadium or chromium or manganese or iron or cobalt or nickel or copper or yttrium or zirconium or niobium or molybdenum or ruthenium or rhodium or palladium or silver or hafnium or tantalum or tungsten or rhenium or osmium or iridium or platinum or gold or combinations thereof.

9. A method as claimed in claim 1, wherein said first material is copper or nickel or iron or steel or titanium or combinations of copper and/or nickel and/or iron and/or steel and/or titanium.

10. A method as claimed in claim 1, wherein said first material is copper or a copper-based alloy.

11. A method as claimed in claim 1, wherein said second material is essentially a polymer.

12. A method as claimed in claim 1, wherein said second material is essentially a metal or a metal alloy.

13. A method as claimed in claim 1, wherein said second material is a brazing alloy.

14. A method as claimed in claim 13, wherein said brazing alloy is a silver-based alloy.

15. A method as claimed in claim 14, wherein the silver content of said brazing alloy is between 25% by weight to 100% by weight.

16. A method as claimed in claim 14, wherein said brazing alloy further comprises copper.

17. A method as claimed in claim 16, wherein the copper content of said brazing alloy is between 0% by weight to 42% by weight.

18. A method as claimed in claim 1, wherein said first exterior surface comprises a top portion and a bottom portion and wherein said sheet is placed either on said top portion or on said bottom portion of said first exterior surface.

19. An open cell porous material as produced by the method of claim 1.

20. A method for at least partially coating an open cell porous body made from a first metallic material having a first melting temperature, said method comprising the steps of:
a. providing said open cell porous body, said body having a first exterior surface;
b. placing a sheet of a second metallic material adjacent to said first exterior surface, said second metallic material having a second melting temperature lower than said first melting temperature, said second metallic material being compatible with said first metallic material;
c. heating said body with said sheet at a third temperature, said third temperature being equal or greater than said second melting temperature but lower than said first melting temperature.

21. A method as claimed in claim 20, wherein said first metallic material comprises at least one transition metal.

22. A method as claimed in claim 21, wherein said at least one transition metal is scandium or titanium or vanadium or chromium or manganese or iron or cobalt or nickel or copper or yttrium or zirconium or niobium or molybdenum or ruthenium or rhodium or palladium or silver or hafnium or tantalum or tungsten or rhenium or osmium or iridium or platinum or gold or combinations thereof.

23. A method as claimed in claim 20, wherein said first metallic material comprises copper or nickel or iron or steel or titanium or combinations of copper and/or nickel and/or iron and/or steel and/or titanium.

24. A method as claimed in claim 20, wherein said first metallic material comprises copper or a copper-based alloy.

25. A method as claimed in claim 20, wherein said second metallic material comprises a brazing alloy.

26. A method as claimed in claim 25, wherein said brazing alloy is a silver-based alloy.

27. A method as claimed in claim 26, wherein the silver content of said brazing alloy is between 25% by weight to 100% by weight.

28. A method as claimed in claim 26, wherein said brazing alloy further comprises copper.

29. A method as claimed in claim 28, wherein the copper content of said brazing alloy is between 0% by weight to 42% by weight.

30. A method as claimed in claim 20, wherein said first exterior surface comprises a top portion and a bottom portion and wherein said sheet is placed either on said top portion or on said bottom portion of said first exterior surface.

31. An open cell porous material as produced by the method of claim 20.

32. A method for at least partially coating an open cell porous body made from copper or a copper-based alloy and having a first melting temperature, said method comprising the steps of:
a. providing said open cell porous body, said body having a first exterior surface;
b. placing a sheet of a silver-based brazing alloy adjacent to said first exterior surface, said silver-based brazing alloy having a second melting temperature lower than said first melting temperature;
c. heating said body with said sheet at a third temperature, said third temperature being equal or greater than said second melting temperature but lower than said first melting temperature.

33. A method as claimed in claim 32, wherein the silver content of said brazing alloy is between 25% by weight to 100% by weight.

34. A method as claimed in claim 32, wherein said brazing alloy further comprises copper.

35. A method as claimed in claim 34, wherein the copper content of said brazing alloy is between 0% by weight to 42% by weight.

36. A method as claimed in claim 32, wherein said first exterior surface comprises a top portion and a bottom portion and wherein said sheet is placed either on said top portion or on said bottom portion of said first exterior surface.

37. An open cell porous material as produced by the method of claim 32.
